(19) United States
(12) Patent Application Publication
(10) Pub. No.: US 2017/0153839 A1
(43) Pub. Date: Jun. 1, 2017

(54) EFFICIENT ON-DEMAND CONTENT-BASED MEMORY SHARING

(71) Applicant: MediaTek Inc., Hsinchu (TW)

(72) Inventors: Chi-Jen Hung, Changhua County (TW); Chung-Jung Lee, Taipei (TW); Nicholas Ching Hui Tang, Hsinchu County (TW); Jia-Ming Chen, Zhubei (TW)

(21) Appl. No.: 15/191,758

(22) Filed: Jun. 24, 2016

Related U.S. Application Data
(60) Provisional application No. 62/260,729, filed on Nov. 30, 2015.

(51) Int. Cl. G06F 3/06

(52) U.S. Cl. CPC G06F 3/0641; G06F 3/0608; G06F 3/0647; G06F 3/0683

(57) ABSTRACT

An efficient, on-demand, content-based memory sharing method is performed by a system. The method begins when an event is detected. The system predicts a merge gain based on a current number of candidate pages in the memory, a current number of merged pages, and a merge ratio which represents a merged-to-candidate page ratio. In response to a determination that the merge gain is greater than a threshold, the system performs a scan and merge operation to merge a set of the candidate pages, which have a same content and have not been merged, into a single page having the same content.

### CROSS-REFERENCE TO RELATED APPLICATIONS

This application claims the benefit of U.S. Provisional Application No. 62/260,729 filed on Nov. 30, 2015.

### TECHNICAL FIELD

Embodiments of the invention relate to memory management, and more specifically, to on-demand sharing of memory units having the same contents.

### BACKGROUND

In a modern computing system, multiple processes may use memory pages that have identical contents. The computing system may be non-virtualized; e.g., the processes may run on the same operating system, or virtualized, e.g., the processes may run on respective guest operating systems in respective virtual machines, which are managed by a host operating system. Generally, the operating system (or the host operating system) adopts a memory management technique to reduce duplication in memory contents, such that memory utilization can be more efficient.

In a computing system, a page—typically 4K bytes in size—is a basic memory unit. A page occupies a contiguous block of memory addresses. A page in the physical address space is referred to as a physical page, and a page in a process' virtual address space is referred to as a virtual page. A page table is used to map the virtual addresses of a virtual page into physical addresses of a physical page. When two physical pages have the same contents, the two pages may be merged into one page such that the physical memory space originally occupied by the other page can be freed and reused. The two virtual pages mapping to the two physical pages can keep their virtual addresses unchanged. After merging of the two pages, the page table may be changed to map both virtual pages to the same physical page.

A computing system may have a large number of pages with the same content. However, the operations of identifying and merging these pages may be a cause for significant system overhead. Therefore, there is a need for a mechanism that performs the merge operations efficiently.

### SUMMARY

In one embodiment, a method is provided for merging pages of a same content on demand. The method comprises: detecting an event for merging candidate pages in a memory; predicting a merge gain based on a current number of the candidate pages, a current number of merged pages, and a merge ratio which represents a merged-to-candidate page ratio. The method further comprises: in response to a determination that the merge gain is greater than a threshold, performing a scan and merge operation to merge a set of the candidate pages, which have a same content and have not been merged, into a single page having the same content.

In another embodiment, a system is provided to merge pages of a same content on demand. The system comprises a memory, and one or more processors coupled to the memory. The one or more processors are operative to: detect an event for merging candidate pages in the memory; predict a merge gain based on a current number of the candidate pages, a current number of merged pages, and a merge ratio which represents a merged-to-candidate page ratio; and in response to a determination that the merge gain is greater than a threshold, perform a scan and merge operation to merge a set of the candidate pages, which have a same content and have not been merged, into a single page having the same content.

Embodiments described herein provide a system and method that support memory sharing with high efficiency. In one embodiment, pages having the same content are merged on demand and when a merge gain exceeds a threshold. The demand-driven approach significantly improves system performance.

### BRIEF DESCRIPTION OF THE DRAWINGS

The present invention is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one. Further, when a particular feature, structure, or characteristic is described in connection with an embodiment, it is submitted that it is within the knowledge of one skilled in the art to effect such feature, structure, or characteristic in connection with other embodiments whether or not explicitly described.

FIG. 1 illustrates a system that performs a scan and merge operation according to one embodiment.

FIG. 2 illustrates operations for merging and demerging pages according to one embodiment.

FIG. 3 illustrates a timeline of on-demand page merging according to one embodiment.

FIG. 4 illustrates is a flow diagram illustrating a method for efficiently share memory according to another embodiment.

FIG. 5 illustrates is a flow diagram illustrating a method for merging pages of the same content on demand according to one embodiment.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description. It will be appreciated, however, by one skilled in the art, that the invention may be practiced without such specific details. Those of ordinary skill in the art, with the included descriptions, will be able to implement appropriate functionality without undue experimentation.

Embodiments of the invention provide a system and method for merging pages of the same content on demand. The system at runtime continuously monitors the state of the system to detect an event that indicates a demand for memory sharing among processes. When the event is detected, the system predicts a merge gain based on a known merge ratio, the current number of candidate pages and the current number of merged pages. When the predicted merge gain exceeds a threshold, a scan and merge operation is performed on the candidate pages. The scan and merge operation first scans the candidate pages to identify pages that have the same content and have not been merged, and then merges these identified pages. If the predicted merge gain does not exceed the threshold, the system will hold off the scan and merge operation until a next event occurs when the predicted merge gain exceeds the threshold.

In one embodiment, the memory is divided into physical pages of a fixed size (e.g., 4K bytes). Some of the physical pages may have the same content, and may be merged to save memory. For example, assume that physical pages PG1 and PG2 have the same content. PG1 and PG2 are mapped to virtual pages VPG1 and VPG2, respectively; that is, VPG1 has a pointer P1 pointing to PG1, and VPG2 has a pointer P2 pointing to PG2. A virtual page is a page that exists in the virtual address space of a process or a program. A virtual page is allocated with memory when the operating system (OS) maps it to a physical page; e.g., by assigning it a pointer pointing to the allocated physical page. When PG2 is merged into PG1, its pointer P2 is modified to point to PG1; as a result, both pointers P1 and P2 point to PG1. After the merge, PG1 is referred to as a shared page that has a merge count of two, and the 4K byte space of PG2 can be released from its current process and reused by another process. Thus, the scan and merge operation allows the same physical page to be shared by multiple processes, and, therefore, improves memory utilization.

Unless explicitly specified otherwise, the term “page” hereinafter refers to “physical page.” In one embodiment, the pages that are candidates for merging are referred to herein as the candidate pages. In one embodiment, candidate pages are anonymous pages, which are the pages that have been allocated to processes or programs. An anonymous page in a Linux™ system is a page that is not part of any files in a file system and may be located in a program's data or stack space. In alternative embodiments, the scan and merge operation may also be applied to other types of pages.

Although some terminologies of Linux™ may be used herein as an example, it is understood that the scan and merge operation described herein is applicable to any system.

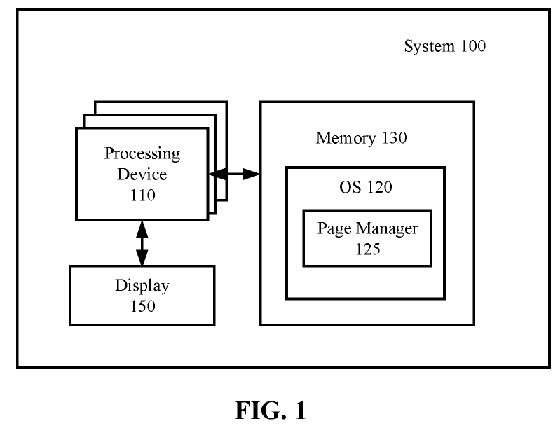

FIG. 1 is a diagram illustrating a system 100 according to one embodiment. The system 100 includes one or more processing devices 110 coupled to a memory 130 and a display 150. Examples of the processing devices 110 include, but are not limited to, central processing units (CPUs), graphics processing units (GPUs), digital signal processors (DSPs), general-purpose processors and special-purpose processors. It is understood that many other system components are omitted herein for simplicity of illustration.

In one embodiment, the system 100 and/or the processing devices 110 may be implemented as a system-on-a-chip (SoC). In one embodiment, the system 100 may be part of a mobile computing and/or communication device (e.g., a smartphone, a tablet, a laptop, etc.). In another embodiment, the system 100 may be part of a server computer. In one embodiment, the memory 130 may be a dynamic random access memory (DRAM), or other volatile or non-volatile random-access memory. The display 150 may have a fixed refreshing frequency (e.g., 60 Hz) marked by a periodic VSYNC signal,

In one embodiment, the system 100 executes an OS 120, which manages the allocation and usage of system resources such as the memory 130. The OS 120 includes a page manager 125, which is responsible for keeping track of candidate pages in the system, and determining when to trigger a scan and merge operation. In an alternative embodiment, the page manager 125 may be implemented in hardware, firmware, software, or a combination of the above.

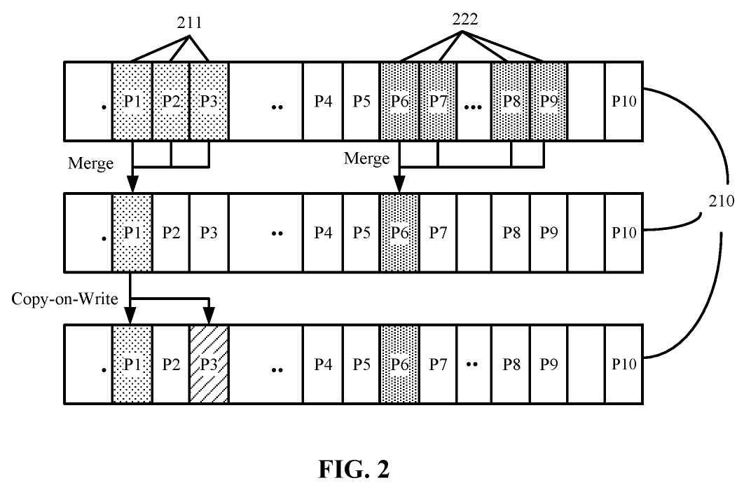

FIG. 2 illustrates an example of merge and demerge operations according to one embodiment. For simplicity of illustration, this example shows ten candidate pages (e.g., P1 to P10) occupying a continuous memory space 210 (e.g., the memory 130 of FIG. 1). However, it is understood that the memory space 210 may include any number of candidate pages, and the candidate pages may be anywhere in the memory 130 and may occupy discontinuous (e.g., fragmented) memory space. Moreover, some of the candidate pages may be adjacent to each other, while some of the other candidate pages may not be adjacent (illustrated by the dotted space not drawn to scale). In this example, a first group 211 of three pages (P1, P2 and P3) have the same content and are merged into a first page, P1. The second group 222 of four pages (P6, P7, P8 and P9) have the same content and are merged into a second page, P6. Pages of the same groups may be located anywhere in the memory space 210. In an alternative embodiment, pages of one group may be interspersed with pages of other groups.

P1 and P6 are referred to as shared pages. Each group of pages that are merged into a page are called merged pages. In the example of FIG. 2, after the merge operation is performed on the two groups 211 and 222, the number of candidate pages remains ten and the number of merged pages is seven. During system runtime, a merged page may be modified. To allow a merged page for modification, a copy-on-write (COW) operation is performed to copy the content of a shared page (e.g., P1) to another page (e.g., P3), and the content of P3 may be modified. Thus, the COW operation demerges P3 from the shared page P1. After the demerge operation, the number of merged pages decreases to six. The number of candidate pages may also change during system runtime when new pages are allocated to a program or process, or when existing pages are deallocated.

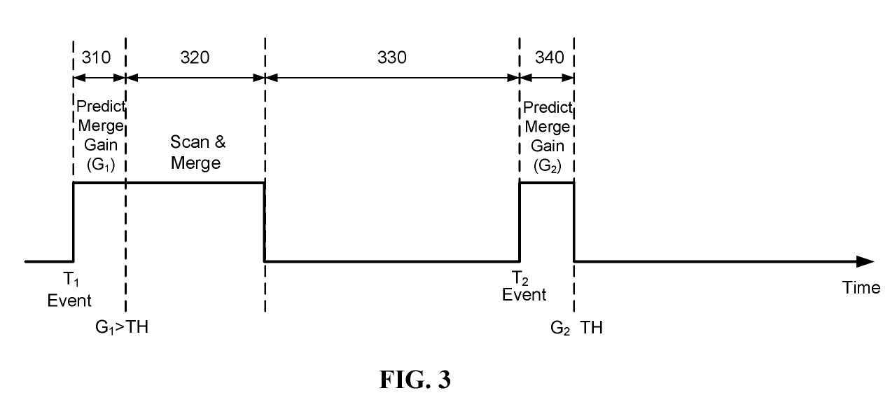

FIG. 3 is a diagram illustrating a timeline for an example of scan and merge operations according to one embodiment. It is understood that the timeline of FIG. 3 is not drawn to scale. The operations illustrated in FIG. 3 may be performed by a memory management unit or process, such as the page manager 125 of FIG. 1. In this example at time instant T₁, the page manager 125 detects an event. In one embodiment, the event may be one or more of the following: when an amount of available memory falls or is predicted to fall below a first threshold, when an amount of changed memory content rises or is predicted to rise above a second threshold, etc.

Upon detection of the event, the page manager 125 proceeds to predict a merge gain during time 310 based on a merge ratio (R), the current number of candidate pages (C) and the current number of merged pages (M). In one embodiment, the merge ratio is an estimated proportion of C that can be merged into one or more pages; in other words, the merge ratio represents the merged-to-candidate page ratio, which is the ratio of the number of merged pages to the number of candidate pages when a scan and merge is performed. During the system runtime, the number of merged pages and/or the number of candidate pages may change. As a result, the ratio of M to C at some point of the runtime may deviate from R. Given the current number of candidate pages (C), one can predict that the product N=C×R will approximate the number of merged pages if another scan and merge operation is performed on these candidate pages. The merge gain (G) is the additional number of merged pages that the system can gain from this scan and merge operation; that is, G=N−M. In some embodiments, the merge gain may be expressed as a ratio or percentage of this additional number of merged pages to N.

In one embodiment, from profiling data collected at runtime on a variety of hardware platforms and a variety of memory usage scenarios, it is shown that the merge ratio generally falls into a narrow numerical range (e.g., 12%-17%). Thus, in one embodiment, a numerical range is determined from the profiling data, and the mean or average of the numerical range is pre-determined as the merge ratio. Then the merge gain may be determined from the merge ratio and the page allocation and sharing information in the system.

Referring back to FIG. 3, it is assumed in this example that the predicted merge gain (G₁) is greater than the threshold (TH). Thus, the page manager 125 proceeds to perform the scan and merge operation during time 320. After all of the candidate pages are scanned and those having the same contents are merged, the page manager 125 performs no further scan and merge operation until a next event is detected. In one embodiment, the page manager 125 runs a process that continuously tracks the number of merged pages and the number of candidate pages. These two numbers are tracked because their changes may cause the merge gain to change as well. At time instant T₂, the page manager 125 detects another event. The memory manager proceeds to predict a merge gain G₂, which is not greater than TH. Thus, the page manager 125 does not perform a scan and merge operation at this point.

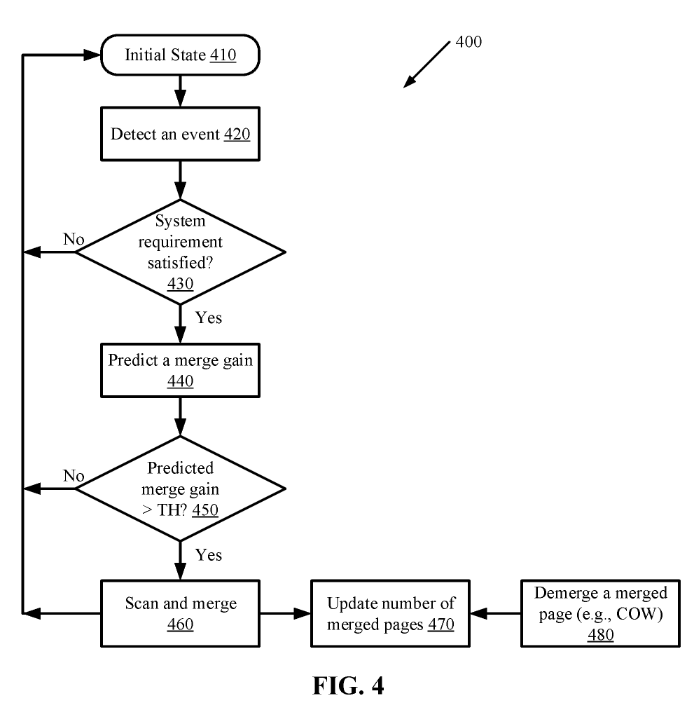

FIG. 4 illustrates a method 400 for a system to efficiently share memory according to one embodiment. In one embodiment, the system may be the system 100 of FIG. 1. The system starts from an initial state 410. When an event is detected at step 420, the system determines whether it has the capacity to proceed with a scan and merge operation at step 430; e.g., whether the system has sufficient available memory to support the internal data structures that may be created during the scan and merge operation. If there is insufficient available memory for the scan and merge operation, the system returns to the initial state 410 until a next event is detected. If there is sufficient available memory for the scan and merge operation, the system calculates a merge gain at step 440, and determines whether the merge gain is greater than a threshold (TH) at step 450. The threshold may be statically assigned or dynamically computed.

If the merge gain is greater than the threshold, the system proceeds with the scan and merge operation at step 460, and returns to the initial state 410 after the operation is completed. If the merge gain is not greater than the threshold, the system returns to the initial state 410 without performing the scan and merge operation. The system may adjust the merge ratio and/or the threshold (TH) in a number of scenarios; for example, if the merge gain is less than TH for a consecutive number of times exceeding a retry limit, or if the detected event indicates that the scan and merge operation needs to be performed more often or less often, etc.

During runtime, the system runs a process that tracks the number of candidate pages and the number of merged pages. The number of merged pages is updated at step 470 to record its increase when pages are merged, and is also updated to record its decrease when merged pages are demerged; e.g., when a copy-on-write (COW) operation is performed at step 480 to enable a merged page to be copied to another page.

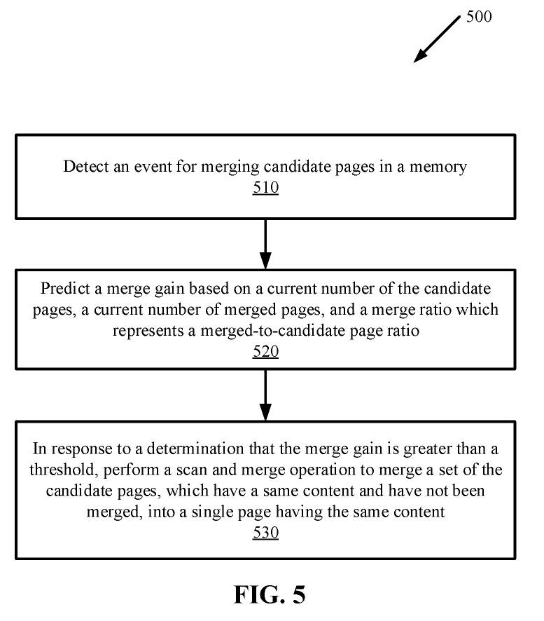

FIG. 5 illustrates a flow diagram of a method 500 for merging pages of the same content on demand according to one embodiment. The method 500 may be performed by a system, such as the system 100 of FIG. 1, or more specifically, the page manager 125. In alternative embodiments, the method 500 may be performed by hardware (e.g., circuitry, dedicated logic, programmable logic, microcode, etc.), software (e.g., instructions run on a processing device), or a combination thereof.

In one embodiment, the method 500 begins when an event is detected for merging candidate pages in a memory (step 510). A merge gain is predicted based on a current number of the candidate pages, a current number of merged pages, and a merge ratio which represents a merged-to-candidate page ratio (step 520). In response to a determination that the merge gain is greater than a threshold, a scan and merge operation is performed on a set of the candidate pages, which have a same content and have not been merged, to merge them into a single page having the same content (step 530).

According to embodiments described herein, page merging may be performed on demand when an event is detected and the merge gain exceeds a threshold. The demand-driven approach significantly improves system performance, as merge operations that cannot produce much gain for the system can be skipped to save system resources.

The operations of the flow diagrams of FIGS. 4 and 5 have been described with reference to the exemplary embodiment of FIG. 1. However, it should be understood that the operations of the flow diagrams of FIGS. 4 and 5 can be performed by embodiment of the invention other than those discussed with reference to FIG. 1, and the embodiment discussed with reference to FIG. 1 can perform operations different than those discussed with reference to the flow diagrams of FIGS. 4 and 5. While the flow diagrams of FIGS. 4 and 5 show a particular order of operations performed by certain embodiments of the invention, it should be understood that such order is exemplary (e.g., alternative embodiments may perform the operations in a different order, combine certain operations, overlap certain operations, etc.).

While the invention has been described in terms of several embodiments, those skilled in the art will recognize that the invention is not limited to the embodiments described, and can be practiced with modification and alteration within the spirit and scope of the appended claims. The description is thus to be regarded as illustrative instead of limiting.

What is claimed is:

1. A method for merging pages of a same content on demand, the method comprising:
detecting an event for merging candidate pages in a memory;
predicting a merge gain based on a current number of the candidate pages, a current number of merged pages, and a merge ratio which represents a merged-to-candidate page ratio; and
in response to a determination that the merge gain is greater than a threshold, performing a scan and merge operation to merge a set of the candidate pages, which have a same content and have not been merged, into a single page having the same content.

2. The method of claim 1, wherein the event is detected when an amount of available memory falls or is predicted to fall below a first threshold.

3. The method of claim 1, wherein the event is detected when an amount of changed memory content rises or is predicted to rise above a second threshold.

4. The method of claim 1, wherein the merge gain indicates a predicted increase in a number of merged pages after another scan and merge operation is performed on the candidate pages.

5. The method of claim 1, further comprising:
updating the current number of merged pages after every scan and merge operation and after every copy-on-write operation performed on a merged page.

6. The method of claim 1, wherein at least one of the threshold and the merge ratio is adjustable at runtime.

7. The method of claim 6, wherein at least one of the threshold and the merge ratio is adjusted when it is determined that the merge gain is not greater than the threshold.

8. The method of claim 1, wherein detecting the event further comprises:
determining whether available memory supports the merging of the set of the candidate pages.

9. The method of claim 1, further comprising:
determining the merge ratio based on profiling statistics collected from one or more of following: a set of different usage scenarios of the memory and a set of different hardware platforms.

10. The method of claim 1, wherein predicting the merge gain further comprises:
proceeding to detect a next event without performing the scan and merge operation for the detected event in response to the determination that the merge gain is not greater than the threshold.

11. A system operative to merge pages of a same content on demand, the system comprising:
a memory; and
one or more processors coupled to the memory, the one or more processors operative to:
detect an event for merging candidate pages in the memory;
predict a merge gain based on a current number of the candidate pages, a current number of merged pages, and a merge ratio which represents a merged-to-candidate page ratio; and
in response to a determination that the merge gain is greater than a threshold, perform a scan and merge operation to merge a set of the candidate pages, which have a same content and have not been merged, into a single page having the same content.

12. The system of claim 11, wherein the event is detected when an amount of available memory falls or is predicted to fall below a first threshold.

13. The system of claim 11, wherein the event is detected when an amount of changed memory content rises or is predicted to rise above a second threshold.

14. The system of claim 11, wherein the merge gain indicates a predicted increase in a number of merged pages after another scan and merge operation is performed on the candidate pages.

15. The system of claim 11, wherein the one or more processors is further operative to:
update the current number of merged pages after every scan and merge operation and after every copy-on-write operation performed on a merged page.

16. The system of claim 11, wherein at least one of the threshold and the merge ratio is adjustable at runtime.

17. The system of claim 16, wherein at least one of the threshold and the merge ratio is adjusted when it is determined that the merge gain is not greater than the threshold.

18. The system of claim 11, wherein the one or more processors upon detection of the event, is further operative to determine whether available memory supports the merging of the set of the candidate pages.

19. The system of claim 11, the one or more processors is further operative to:
determine the merge ratio based on profiling statistics collected from one or more of following: a set of different usage scenarios of the memory and a set of different hardware platforms.

20. The system of claim 11, wherein the one or more processors is further operative to:
proceed to detect a next event without performing the scan and merge operation for the detected event in response to the determination that the merge gain is not greater than the threshold.
